(19) United States
(12) Patent Application Publication
(10) Pub. No.: US 2023/0024419 A1
(43) Pub. Date: Jan. 26, 2023

(54) SYSTEM AND METHOD FOR DYNAMICALLY CONFIGURABLE REMOTE DATA COLLECTION FROM A VEHICLE

(71) Applicant: GM GLOBAL TECHNOLOGY OPERATIONS LLC, Detroit, MI (US)

(72) Inventors: Chuan Li, Troy, MI (US); Fan Bai, Ann Arbor, MI (US); Donald K. Grimm, Utica, MI (US); Massimo Osella, Oakland Township, MI (US); Nikhil L. Hoskeri, Ann Arbor, MI (US); Wardah J. Khan, Bloomfield Hills, MI (US)

(73) Assignee: GM GLOBAL TECHNOLOGY OPERATIONS LLC, Detroit, MI (US)

(21) Appl. No.: 17/383,592

(22) Filed: Jul. 23, 2021

(51) Int. Cl. G05D 1/02; G06F 9/48; H04W 4/40

(52) U.S. Cl. CPC G05D 1/0287; G06F 9/4881; H04W 4/40; G05D 2201/0213

(57) ABSTRACT

A method and system for dynamically configurable remote data collection from a subject vehicle in response to a task-specific data query is described. This includes the subject vehicle, and a second controller that wirelessly communicates with the subject vehicle, wherein the second controller is an off-board controller that is located remote from the subject vehicle. In one embodiment, the off-board controller is an element of a cloud computing system.

### INTRODUCTION

The present disclosure relates to vehicles, extra-vehicle communications, and real-time acquisition of data from vehicles. Extra-vehicle communication includes short-range vehicle-to-vehicle (V2V) communication, vehicle-to-infrastructure communication, communication to other intelligent highway systems, and communication to remote controllers for managing vehicle deployment, maintenance, fault diagnostics, etc.

There is a need for data collection from vehicles that is dynamically configurable to facilitate identifying and gathering relevant data in real-time, with on-demand data collection being contextually triggerable. There is a need to support task automation for data collection to expedite back-office development processes. It is desirable to have a mechanism for remotely-configurable collection of data gathered by a vehicle, wherein the data may be in the form of sensor data, subsystem data, system data, or vehicle data.

### SUMMARY

A subject vehicle is described, and includes vehicle sensors, first-level controllers, second-level controllers, one or multiple data watcher routines, a data compiler, a configuration manager, and a telematics system for extra-vehicle communication.

A method and system for dynamically configurable remote data collection from a subject vehicle in response to a task-specific data query is described. This includes the subject vehicle, and a second controller that wirelessly communicates with the subject vehicle, wherein the second controller is an off-board controller that is located remote from the subject vehicle. In one embodiment, the off-board controller is an element of a cloud computing system.

The vehicle sensors, the first-level controllers, and the second-level controllers generate a plurality of parameters. The second controller generates a task-specific data query to obtain a subset of the plurality of parameters in response to a request from an external application. The second controller communicates, via the telematics system, the task-specific data query to the configuration manager to request the subset of the plurality of parameters, and the data watcher routine captures and communicates the subset of the plurality of parameters to the data compiler. The data compiler communicates the subset of the plurality of parameters to the second controller.

An aspect of the disclosure includes the second controller structuring the plurality of parameters into a data hierarchy, wherein the second controller generates the task-specific data query to obtain the subset of the plurality of parameters that is consistent with the data hierarchy that is arranged by the data compiler.

Another aspect of the disclosure includes the data hierarchy being arranged, via the configuration manager, to include sensor data, subsystem data, system data, and vehicle data.

Another aspect of the disclosure includes the task-specific data query being iterative, including the configuration manager being arranged to initially request vehicle data, and at least one of a request for system data, a request for subsystem data, and a request for sensor data in response to the task-specific data query. The data watcher routine captures and communicates the subset of the plurality of parameters to the data compiler.

Another aspect of the disclosure includes the second controller being configured to arrange the task-specific data query to obtain the subset of the plurality of parameters such that the task-specific data query requests data that is consistent with a data hierarchy of the configuration manager, including sensor data, subsystem data, system data, and vehicle data.

Another aspect of the disclosure includes the configuration manager being arranged to request the subset of the plurality of parameters in response to the task-specific data query, wherein the subset of the plurality of parameters includes one of vehicle data, system data, subsystem data, or sensor data, and wherein the data watcher routine captures and communicates the subset of the plurality of parameters to the data compiler.

Another aspect of the disclosure includes the second controller being a cloud-based controller.

Another aspect of the disclosure includes the task-specific data query being iterative, including the second controller being arranged to request data from proximal, similarly situated vehicles in response to the task-specific data query.

Another aspect of the disclosure includes the second controller being arranged to request data from proximal, similarly situated vehicles in response to the task-specific data query at a same hierarchical data level as the subject vehicle in response to the task-specific data query.

Another aspect of the disclosure includes the task-specific data query being iterative, and wherein the second controller is arranged to request data from a proximal, similarly situated vehicle at a same hierarchical data level as the subject vehicle in response to the task-specific data query.

Another aspect of the disclosure includes the plurality of vehicle sensors being arranged to monitor operation of the subject vehicle.

Another aspect of the disclosure includes the plurality of first-level controllers being dedicated controllers that execute task-specific operations.

Another aspect of the disclosure includes the plurality of second-level controllers being system-level controllers that monitor and control the plurality of first-level controllers.

Another aspect of the disclosure includes a method for collecting data from a subject vehicle that includes generating, via a second controller, a task-specific data query to obtain a plurality of parameters in response to a request from an external application. The task-specific data query is communicated, via a telematics system, to an on-vehicle configuration manager to request the plurality of parameters, and an on-vehicle data compiler captures the plurality of parameters. The plurality of parameters are communicated to the second controller. The plurality of parameters are arranged in a data hierarchy, and the second controller generates the task-specific data query to obtain the plurality of parameters that is consistent with the data hierarchy.

The concepts provide a system that is dynamically configurable to identify and obtain relevant data in real-time, and is contextually triggerable for data collection on demand, thus supporting task automation to expedite back-office development process. The vehicle data hierarchy coupled with a closely coordinated vehicle/cloud framework facilitates elastically exercising iterative control over running data collection tasks after their deployments to find relevant data. This arrangement supports task automation and thus reduces or eliminates the need for cloud-side human interventions, and expedites data collection task development process for refinement and enhancement. This system is especially suitable for time-sensitive, information-rich applications, such as raw data on-demand collection for traffic light perception.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

One or more embodiments will now be described, by way of example, with reference to the accompanying drawings, in which:

FIG. 1 schematically shows elements of a data capture system for remotely and dynamically gathering parameters from a subject vehicle, in accordance with the disclosure.

FIG. 2 schematically shows a system architecture for a data capture system, in accordance with the disclosure.

FIG. 3 schematically illustrates an information structure associated with a data watcher routine for a data capture system, in accordance with the disclosure.

FIG. 4 schematically illustrates an embodiment of hierarchical vehicle data for a data capture system, in accordance with the disclosure.

FIG. 5 schematically illustrates iterative operation of a data capture system, in accordance with the disclosure.

FIG. 6 pictorially illustrates operation of an adaptive 2-dimensional zoom-in search algorithm for a data capture system, in accordance with the disclosure.

It should be understood that the appended drawings are not necessarily to scale, and present a somewhat simplified representation of various preferred features of the present disclosure as disclosed herein, including, for example, specific dimensions, orientations, locations, and shapes. Details associated with such features will be determined in part by the particular intended application and use environment.

### DETAILED DESCRIPTION

The components of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description in order to provide a thorough understanding of the embodiments disclosed herein, some embodiments can be practiced without some of these details. Moreover, for the purpose of clarity, certain technical material that is understood in the related art has not been described in detail in order to avoid unnecessarily obscuring the disclosure.

As used herein, the term “system” refers to one of or a combination of mechanical and electrical actuators, sensors, controllers, application-specific integrated circuits (ASIC), combinatorial logic circuits, software, firmware, and/or other components that are arranged to provide the described functionality.

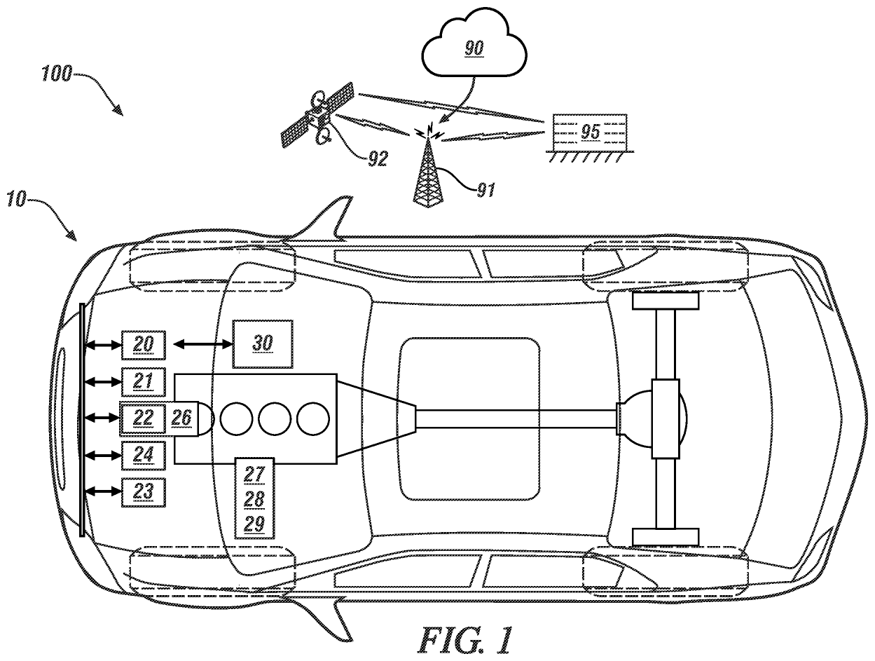

Referring now to the drawings, wherein the showings are for the purpose of illustrating certain exemplary embodiments and not for the purpose of limiting the same, FIG. 1 schematically shows an embodiment of a data capture system 100 for remotely and dynamically gathering parameters from a subject vehicle 10. The data capture system 100 includes a second controller 95 in communication with the subject vehicle 10. The second controller 95 is an off-board controller that is located remote from the subject vehicle 10 and wirelessly communicates with the subject vehicle 10. In one embodiment, the second controller 95 is an element of a cloud-based computing system (cloud) 90.

The subject vehicle 10 includes systems, components and sensors employed by a propulsion system 27, a steering system 28, and a braking system 29 that are employed for acceleration, steering, and braking, respectively, of the vehicle 10. This includes, in some embodiments, an autonomous operating system 20. The subject vehicle 10 also may include, in one embodiment, systems, components and sensors related to a spatial monitoring system 24; systems, components and sensors related to a navigation system 22; and systems, components and sensors related to human-machine interfaces (HMI) 23. The subject vehicle 10 may also include, in one embodiment, an on-board navigation map 26 that is accessible to and separate from the navigation system 22, a Global Position System (GPS) sensor 21, and a telematics device 30. Other controllable vehicle systems may include, e.g., suspension systems, ride-and-handling systems, ventilation (heat/ventilation/air conditioning), infotainment, etc.

The telematics device 30, which includes a wireless telematics communication system capable of extra-vehicle communications, including communicating with a communication network system having wireless and wired communication capabilities. The telematics device 30 is capable of extra-vehicle communications that includes short-range vehicle-to-vehicle (V2V) communication and/or vehicle-to-infrastructure communication, which may include communication with an infrastructure monitor, e.g., a traffic camera, or other intelligent highway systems. Alternatively or in addition, the telematics device 30 has a wireless telematics communication system capable of short-range wireless communication to a handheld device, e.g., a cell phone, a satellite phone or another telephonic device. In one embodiment the handheld device is loaded with a software application that includes a wireless protocol to communicate with the telematics device 30, and the handheld device executes the extra-vehicle communication, including communicating with the second controller 95 via a communication network that may include, e.g., a satellite 92, an antenna 91, and/or another communication mode. Alternatively, or in addition, the telematics device 30 executes the extra-vehicle communication directly by communicating with the second controller 95 via the communication network.

The vehicle spatial monitoring system 24 includes a spatial monitoring controller in communication with a plurality of sensing devices. The vehicle spatial monitoring system 24 dynamically monitors an area proximate to the subject vehicle 10 and generates digital representations of observed or otherwise discerned remote objects. The spatial monitoring system 24 can determine a linear range, relative speed, and trajectory of each proximate remote object. The sensing devices of the spatial monitoring system 24 may include, by way of non-limiting descriptions, front corner sensors, rear corner sensors, rear side sensors, side sensors, a front radar sensor, and a camera in one embodiment, although the disclosure is not so limited. Placement of the aforementioned sensors permits the spatial monitoring system 24 to monitor traffic flow including proximate vehicles and other objects around the subject vehicle 10. Data generated by the spatial monitoring system 24 may be employed by a lane mark detection processor (not shown) to estimate the roadway. The sensing devices of the vehicle spatial monitoring system 24 can further include object-locating sensing devices including range sensors, such as FM-CW (Frequency Modulated Continuous Wave) radars, pulse and FSK (Frequency Shift Keying) radars, and lidar (Light Detection and Ranging) devices, and ultrasonic devices which rely upon effects such as Doppler-effect measurements to locate forward objects. The possible object-locating devices include charged-coupled devices (CCD) or complementary metal oxide semi-conductor (CMOS) video image sensors, and other camera/video image processors which utilize digital photographic methods to ‘view’ forward and/or rear objects including one or more object vehicle(s). Such sensing systems are employed for detecting and locating objects in automotive applications and are useable with autonomous operating systems including, e.g., adaptive cruise control, autonomous braking, autonomous steering and side-object detection.

The HMI 23 provides for human/machine interaction, for purposes of directing operation of the aforementioned vehicle systems. The HMI 23 monitors operator requests and provides information to the operator including status of vehicle systems, service and maintenance information. The HMI 23 communicates with and/or controls operation of a plurality of in-vehicle operator interface device(s). The HMI system 23 may also communicate with one or more devices that monitor biometric data associated with the vehicle operator, including, e.g., eye gaze location, posture, and head position tracking, among others. The HMI 23 is depicted as a unitary device for ease of description, but may be configured as a plurality of controllers and associated sensing devices in an embodiment of the system described herein. The in-vehicle operator interface device(s) can include devices that are capable of interacting with a vehicle operator, and can include an electronic visual display module, e.g., a liquid crystal display (LCD) device, a heads-up display (HUD), an audio feedback device, a wearable device and a haptic seat.

The autonomous operating system 20, where employed, is disposed to provide a level of autonomous vehicle operation. The autonomous operating system 20 includes a controller and one or a plurality of subsystems that may include an autonomous steering system, an adaptive cruise control system, an autonomous braking/collision avoidance system, a lane change control system, and/or other systems that are configured to command and control autonomous vehicle operation separate from or in conjunction with operator requests. Autonomous operating commands may be generated to control the autonomous steering system, the adaptive cruise control system, the autonomous braking/collision avoidance system and/or the other systems. Vehicle operation includes operation in one of the propulsion modes in response to desired commands, which can include operator requests and/or autonomous vehicle requests. Vehicle operation, including autonomous vehicle operation includes acceleration, braking, steering, steady-state running, coasting, and idling. Operator requests can be generated based upon operator inputs to an accelerator pedal, a brake pedal, a steering wheel, a transmission range selector, and a cruise control system via elements of the HMI 23.

The second controller 95 may be part of the cloud 90 or another form of a back-office computing system associated with a service provider. The term “cloud” and related terms may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The term “controller” and related terms such as control module, module, control, control unit, processor and similar terms refer to one or various combinations of Application Specific Integrated Circuit(s) (ASIC), Field-Programmable Gate Array (FPGA), electronic circuit(s), central processing unit(s), e.g., microprocessor(s) and associated non-transitory memory component(s) in the form of memory and storage devices (read only, programmable read only, random access, hard drive, etc.). The non-transitory memory component is capable of storing machine readable instructions in the form of one or more software or firmware programs or routines, combinational logic circuit(s), input/output circuit(s) and devices, signal conditioning and buffer circuitry and other components that can be accessed by one or more processors to provide a described functionality. Input/output circuit(s) and devices include analog/digital converters and related devices that monitor inputs from sensors, with such inputs monitored at a preset sampling frequency or in response to a triggering event. Software, firmware, programs, instructions, control routines, code, algorithms and similar terms mean controller-executable instruction sets including calibrations and look-up tables. Each controller executes control routine(s) to provide desired functions. Routines may be executed at regular intervals, for example each 100 microseconds during ongoing operation. Alternatively, routines may be executed in response to occurrence of a triggering event. Communication between controllers, and communication between controllers, actuators and/or sensors may be accomplished using a direct wired point-to-point link, a networked communication bus link, a wireless link or another suitable communication link, and is indicated by data link 25. Communication includes exchanging data signals in suitable form, including, for example, electrical signals via a conductive medium, electromagnetic signals via air, optical signals via optical waveguides, and the like. The data signals may include discrete, analog or digitized analog signals representing inputs from sensors, actuator commands, and communication between controllers. The term “signal” refers to a physically discernible indicator that conveys information, and may be a suitable waveform (e.g., electrical, optical, magnetic, mechanical or electromagnetic), such as DC, AC, sinusoidal-wave, triangular-wave, square-wave, vibration, and the like, that is capable of traveling through a medium.

A parameter is defined as a measurable quantity that represents a physical property of a device or other element that is discernible using one or more sensors and/or a physical model. A parameter can have a discrete value, e.g., either “1” or “0”, or can be infinitely variable in value.

As used herein, the terms ‘dynamic’ and ‘dynamically’ describe steps or processes that are executed in real-time and are characterized by monitoring or otherwise determining states of parameters and regularly or periodically updating the states of the parameters during execution of a routine or between iterations of execution of the routine.

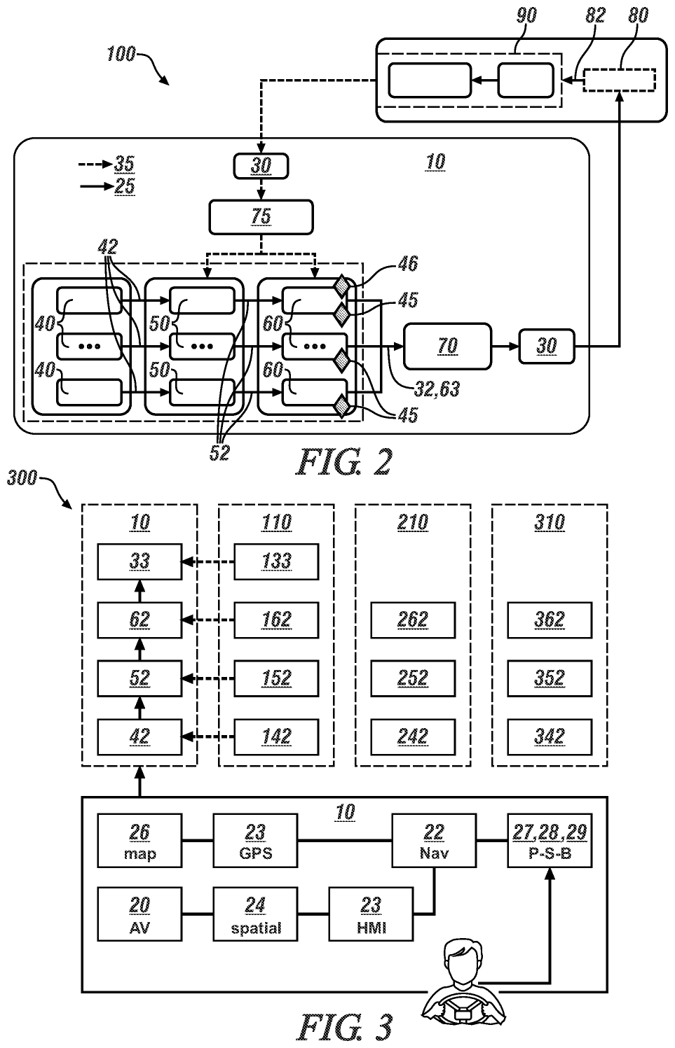

FIG. 2 schematically illustrates a system architecture for an embodiment of the data capture system 100 of FIG. 1. The data capture system 100 includes the cloud 90 including the second controller 95, which is in communication with the subject vehicle 10 via one or more control links 35 and one or more data links 25. The data capture system 100 is tasked with remotely and dynamically requesting selected parameters 32 from the subject vehicle 10 via the control link 35 that is communicated to a configuration manager 75 of the subject vehicle 10 in response to a task-specific data query 82 that is generated by an external application 80. The data capture system 100 is further tasked with gathering the selected parameters 32 from the subject vehicle 10 via an on-board data compiler 70. The data capture system 100 is further tasked with communicating the selected parameters 32 to the second controller 95 via the data link 25.

The task-specific data query 82 may be iterative, with the external application 80 being arranged to initially request vehicle data, followed by a request for system data, followed by a request for subsystem data, followed by a request for sensor data, depending upon the results of the task-specific data query 82 and the information needs of the external application 80. The data watcher routine 45 captures and communicates a subset of the plurality of parameters to the data compiler 70.

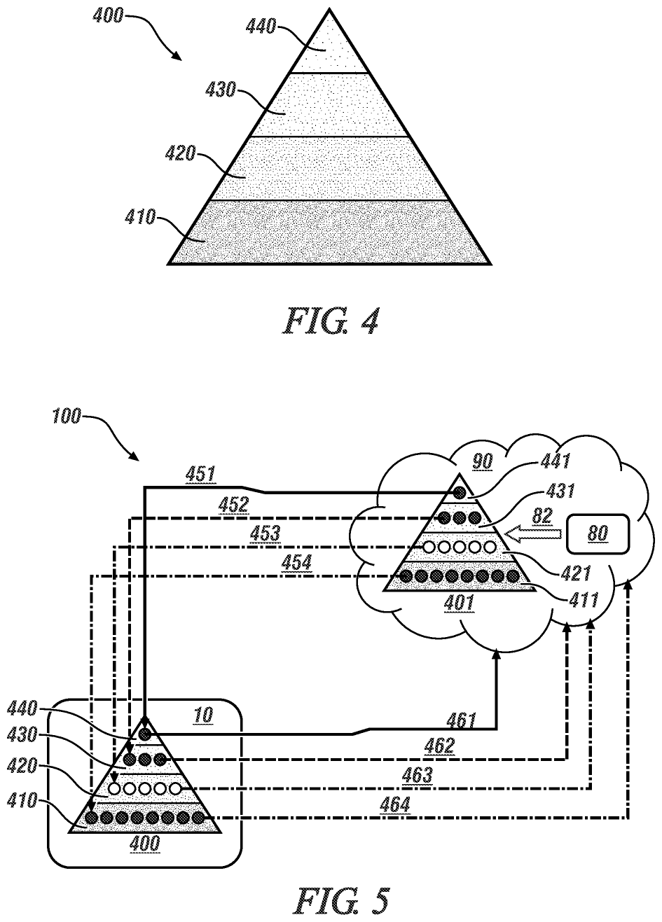

The subject vehicle 10 includes a plurality of vehicle sensors 40, a plurality of first-level controllers 50, and a plurality of second-level controllers 60. The vehicle sensors 40, the first-level controllers 50, and the second-level controllers 60 are employed by the autonomous operating system 20, the GPS sensor 21, the navigation system 22, the HMI 23, the spatial monitoring system 24, the on-board navigation map 26, the propulsion system 27, the steering system 28, the braking system 29, etc., that are described with reference to FIG. 1. The vehicle sensors 40, the first-level controllers 50, and the second-level controllers 60 generate sensor data, subsystem data, system data, and vehicle data. The sensor data, subsystem data, system data, and vehicle data from the subject vehicle are arranged as hierarchical vehicle data 400, as described with reference to FIG. 4.

The selected parameters 32 that are captured from one or more of the vehicle sensors 40, the first-level controllers 50, and the second-level controllers 60 include parameters that are available from one or more of the autonomous operating system 20, the GPS sensor 21, the navigation system 22, the HMI 23, the spatial monitoring system 24, the on-board navigation map 26, the propulsion system 27, the steering system 28, the braking system 29, etc.

The subject vehicle 10 includes a plurality of vehicle sensors 40 that are arranged to monitor parameters. The vehicle sensors 40 are in communication with a corresponding plurality of first-level controllers 50 via data links 25. Non-limiting examples of the vehicle sensors 40 include sensors for the autonomous operating system 20, the GPS sensor 21, the navigation system 22, the HMI 23, the spatial monitoring system 24, the on-board navigation map 26, the propulsion system 27, the steering system 28, the braking system 29, etc.

The subject vehicle 10 includes a plurality of first-level controllers 50. The first-level controllers 50 are dedicated controllers that execute task-specific operations. Each of the first-level controllers 50 is arranged to capture sensor data 42 from one or more of the vehicle sensors 40 and generate subsystem data 52 based thereon.

The subject vehicle 10 includes a plurality of second-level controllers 60. The second-level controllers 60 are system controllers that execute system-level operations. Each of the second-level controllers 60 is arranged to capture subsystem data 52 from one or more of the first-level controllers 50 and generate system data 62. Systems that employ the second-level controllers 60 include, by way of non-limiting examples, the autonomous operating system 20, the navigation system 22, the HMI 23, the spatial monitoring system 24, the propulsion system 27, the steering system 28, the braking system 29, etc. Each of the systems includes subsystems, components and sensors that operate to provide a function associated with operation of the system.

Each of the second-level controllers 60 includes a data watcher routine 45, which is arranged to capture the selected parameters 32 from the sensor data, subsystem data, and system data that is generated by one or more of the vehicle sensors 40, the first-level controllers 50, and/or the second-level controllers 60. One of the second-level controllers 60 includes a vehicle-level data watcher routine 46, which is arranged to capture selected vehicle-level data parameters 63 that is generated by one or more of the vehicle sensors 40, the first-level controllers 50, and/or the second-level controllers 60. The vehicle-level data parameters 63 are part of the parameters 32.

The data watcher routines 45 communicate the selected parameters 32 and the vehicle-level data parameters 63 to the data compiler 70. The data compiler 70 communicates the selected parameters 32 to the cloud 90 via the telematics device 30.

The data watcher routines 45 monitor the vehicle sensors 40, the first-level controllers 50, and the second-level controllers 60 and dynamically capture the selected parameters 32, which are communicated to the compiler 70 in response to the task-specific data query 82. This is described with additional detail with reference to FIG. 3.

The external application 80 is an element of the cloud 90. In one embodiment, the external application 80 supplies information to an intelligent vehicle highway system, an intelligent transportation system, an intelligent highway system, a highway traffic management system, or another system.

The data capture system 100 provides a collaborative system between the vehicle data watcher routines 45, 46 arranged on-vehicle and the second controller 95 to provide a cloud-based query system that has zoom-in capability that incorporates a structure vehicle data hierarchy. This arrangement brings iterative real-time task control and arranged vehicle data collection together. The data hierarchy is defined on the cloud 90, possibly by domain experts, and implemented via the second controller 95. The vehicle-side of the data capture system 100 will get an exactly copy of the hierarchy definition. Once the cloud generates requests based on the hierarchy, the vehicle side can operate accordingly. For example, if cloud ask a vehicle to go one level deeper, the vehicle will figure out what are the vehicle data in the next level. Individual vehicles do not define data hierarchy.

FIG. 3 schematically illustrates an information structure 300 associated with the data watcher routines 45, 46 that may be an element of the data capture system 100 of FIG. 2. The vehicle 10 includes the autonomous operating system (AV) 20, the GPS sensor (GPS) 21, the navigation system (Nav) 22, the HMI 23, the spatial monitoring system (Spatial) 24, the on-board navigation map (Map) 26, the propulsion system (P) 27, the steering system (S) 28, the braking system (B) 29, etc., which generate sensor data 42 from the vehicle sensors 40, subsystem data 52 from the first-level controllers 50, system data 62 from the second-level controllers 60 and HMI data 33 indicating a driver intervention from the HMI 23.

The information structure 300 may also include data from similarly-situated vehicles that are proximal to the subject vehicle 10, including, by way of non-limiting examples, second vehicle 110, third vehicle 210, and fourth vehicle 310. By way of non-limiting examples, the second vehicle 110 may be queried by the external application 80 described with reference to FIG. 1 to provide sensor data 142 from first vehicle sensors of the second vehicle 110, subsystem data 152 from first-level controllers of the second vehicle 110, system data 162 from the second-level controllers of the second vehicle 110, and HMI data 133 indicating a driver intervention from the HMI of the second vehicle 110.

By way of non-limiting examples, the third vehicle 210 may provide sensor data 242 from first vehicle sensors of the third vehicle 210, subsystem data 252 from first-level controllers of the third vehicle 210, and system data 262 from the second-level controllers of the third vehicle 210 in response to a query by the external application 80 described with reference to FIG. 1.

By way of non-limiting examples, the fourth vehicle 310 may provide sensor data 342 from first vehicle sensors of the fourth vehicle 310, subsystem data 352 from first-level controllers of the fourth vehicle 310, and system data 362 from the second-level controllers of the fourth vehicle 310 by the external application 80 described with reference to FIG. 1.

The data watcher routine 45 may be employed to identify or infer vehicle system issues based upon data inconsistencies between mean and outlier data for sensor data, inconsistencies between the vehicle-level data 62 and system-level data 52, inconsistencies between the vehicle-level data 62 and a driver intervention that is indicated by the HMI data 33, and other inconsistencies. The data watcher routine 45 may be employed to identify or infer vehicle system issues based upon data inconsistencies between the vehicle-level data for the subject vehicle and vehicle-level data for similarly-situated vehicles that are proximal to the subject vehicle 10.

The parameters from the subject vehicle 10 are arranged as hierarchical vehicle data 400 that includes sensor data, subsystem data, system data, and vehicle data. FIG. 4 schematically illustrates, with continued reference to the data capture system 100 of FIG. 1, an embodiment of hierarchical vehicle data 400 for the subject vehicle 10, which can be comprehended by and accessed by the data watcher routine 45 for the subject vehicle 10. The hierarchical vehicle data 400 includes the sensor data 410, subsystem data 420, system data 430, and vehicle-level data 440, which is depicted as a pyramid to indicate relative quantities of data that are generated and thus available. The sensor data 410 may be ultra-detailed, with the subsystem data 420, system data 430, and vehicle-level data 440 having less detailed data or being in the form of summary data. The vehicle 10 and the second controller 95 have common definitions for the data hierarchy, which facilitates arrangement and execution of queries. The task-specific data query 82 may initially include a low frequency casual monitor query, which may be transformed to a high-frequency and/or high resolution query in response to a request for a closer investigation that is generated by the external application 80. Responding to a query request for vehicle-level data 440 consumes less communication bandwidth than a query request for sensor data 410 due to the lower magnitude of data being transmitted.

The arrangement of the hierarchical vehicle data 400 in association with the data watcher routine 45 of the data capture system 100 of FIG. 1 provides for a dynamic, context-driven multi-level data inquiry mechanism having a zoom-in capability that utilizes a well-defined, multi-level vehicle data pyramid framework. This enables a lightweight cloud-assisted, remotely configurable vehicle data collection mechanism. The in-vehicle data watcher routines 45 monitor vehicle data against triggers obtained from queries that are generated locally or by one or more applications 80 in the cloud 90, and submit data reports having the requisite level of detail to the application(s) 80 in the cloud 90 for analysis. The system is integrated well with applications and can control tasks in real-time with low overhead.

FIG. 5 schematically illustrates iterative operation of the data capture system 100 to remotely and dynamically gather selected parameters from the subject vehicle 10 and communicate them to the cloud 90 in response to the task-specific data query 82 that is generated by the external application 80. The data capture system 100 includes a multi-level data inquiry mechanism employing a well-defined, multi-level vehicle data pyramid framework in the form of the hierarchical vehicle data 400, and a corresponding cloud-side data hierarchy 401. Operation of the data capture system 100 employs an iterative process to gather selected parameters from the subject vehicle 10 and communicate them to the cloud 90 in response to the task-specific data query 82, as follows. As illustrated, the task-specific data query 82 generated by the external application 80 may initiate a vehicle-level data request 441 from the subject vehicle 10 via a first control link 451, with the vehicle-level data 440 being generated and communicated to the cloud 90 via a first communication link 461. After evaluation, the task-specific data query 82 may initiate a system data request 431 from the subject vehicle 10 via a second control link 452, with the system data 430 being generated and communicated to the cloud 90 via a second communication link 462. After further evaluation, the task-specific data query 82 may initiate a subsystem data request 421 from the subject vehicle 10 via a third control link 453, with the subsystem data 420 being generated and communicated to the cloud 90 via a third communication link 463. After further evaluation, the task-specific data query 82 may initiate a sensor data request 411 from the subject vehicle 10 via a fourth control link 454, with the sensor data 410 being generated and communicated to the cloud 90 via a fourth communication link 464.

The task-specific data query 82 may generate system data requests from the hierarchical vehicle data 400 includes the sensor data 410, subsystem data 420, system data 430, vehicle-level data 440, or combinations thereof. The hierarchical vehicle data 400 includes the sensor data 410, subsystem data 420, system data 430, and vehicle data 440.

Under certain conditions, data from different levels can be collected. As the cloud obtains additional data, the data may contain more details which can help the cloud process better define the conditions for data collection. This may be useful when conditions for vehicle data level collection differ from conditions for sensor data level collection.

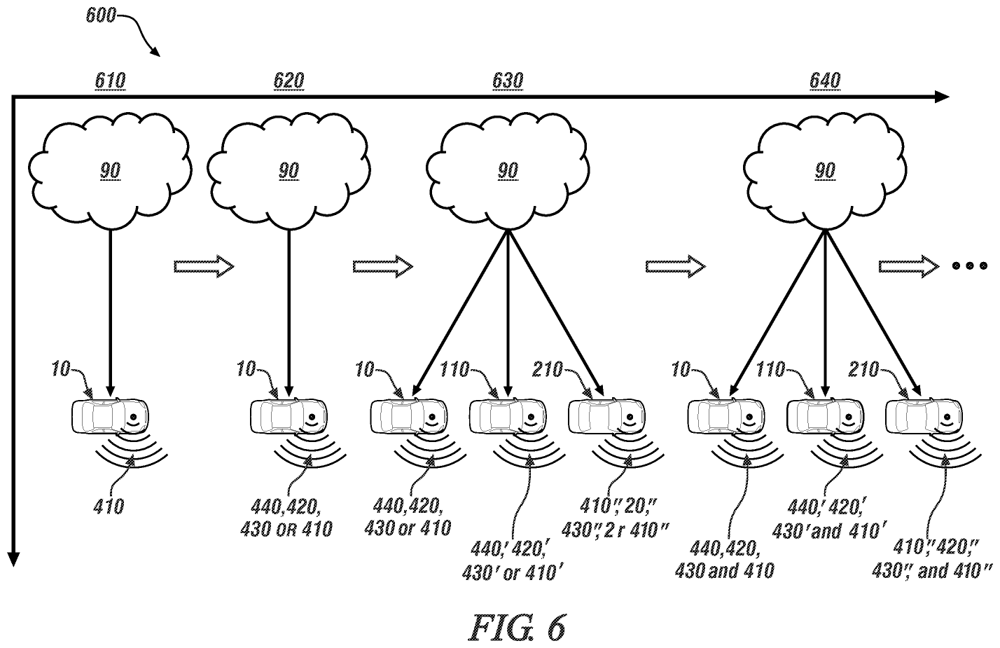

FIG. 6 pictorially illustrates operation of an adaptive 2-dimensional zoom-in search algorithm 600 that is an element of the data capture system 100 of FIG. 1. The adaptive 2-dimensional zoom-in search algorithm 600 executes to collect sufficient data from the subject vehicle 10 and similarly-situated vehicles that are proximal to the subject vehicle 10 to perform an analysis, such as determining occurrence and root cause of a change in a traffic pattern, determining status of a traffic signal, etc. The two-dimensional aspect refers to the capability to gather data from proximal similarly-situated vehicles 110, 210, and to gather additional data at increasingly complex levels, with an associated data communication and analysis burden.

At a first layer 610, the data capture system 100 to monitors vehicle data from the subject vehicle 10 at a first level in response to an initial task-specific data query 82, and communicates the first level data to the cloud 90. The first level corresponds to the vehicle data 440 of the hierarchical vehicle data 400 described with reference to FIG. 4.

At a second layer 620, there may be a need for additional data based upon an analysis of the first level data, the adaptive 2-dimensional zoom-in search algorithm 600 may update the initial task-specific data query 82 to gather data that includes the first level data 440 by zooming in on a system, subsystem, and/or sensor. This includes gathering one of selected system data 430, selected subsystem data 420, or selected sensor data 410 from the subject vehicle 10. This may be an iterative process that instructs the data capture system 100 to monitor vehicle data against triggers obtained from the subject vehicle 10 and/or the cloud 90 to determine what data needs to be selected.

At a third layer 630, there may be a need or a request for additional vehicle data to be gathered from similarly-situated vehicles 110, 210 that are proximal to the subject vehicle 10. There may need to be an intermediate step to identify which proximal vehicles are configured to generate vehicle data that is compatible to the hierarchical vehicle data 400 employed by the subject vehicle 10, including the sensor data 410, subsystem data 420, system data 430, and vehicle-level data 440. At the third layer 630, the proximal similarly-situated vehicles 110, 210 are queried at the same level as the subject vehicle 10. Specifically, the adaptive 2-dimensional zoom-in search algorithm 600 may update the initial task-specific data query 82 to gather data at the first level data, indicated by first level data 440′ from vehicle 110 and first level data 440″ from vehicle 210. Furthermore, the adaptive 2-dimensional zoom-in search algorithm 600 may update the initial task-specific data query 82 to gather data at a second level by zooming in on one of a system, subsystem, or sensor to gather selected system data 430′, 430″, selected subsystem data 420′, 420″ or selected sensor data 410′, 420″ from the proximal similarly-situated vehicle 110, 210, respectively.

At a fourth layer 640, there may be a need or a request for additional vehicle data to be gathered from the subject vehicle 10 and the similarly-situated vehicles 110, 210 that are proximal to the subject vehicle 10. At the fourth layer 640, the subject vehicle 10 and the proximal similarly-situated vehicles 110, 210 are queried at the same level as the subject vehicle 10. Specifically, the adaptive 2-dimensional zoom-in search algorithm 600 may update the initial task-specific data query 82 to gather additional data that includes the first level data 440, 440′, and 440″ by zooming in on a system, subsystem, and/or sensor, to gather selected system data 430, 430′, 430″, selected subsystem data 420, 420′, 420″, and selected sensor data 410, 410′, 410″ from the subject vehicle 10 and the proximal similarly-situated vehicles 110, 210, respectively.

The use of the 2-dimensional data hierarchy employing the adaptive 2-dimensional zoom-in search algorithm 600 permits the second controller 90 to identify proximal vehicles for inclusion or exclusion based upon identification of incorrect outputs, and overfitting against known correct data with minimal or no human intervention. One or multiple vehicles may be identified by the adaptive 2-dimensional zoom-in search algorithm 600 for interrogation and zoom-in data queries, with factors evaluated to determine if the vehicle has the communication bandwidth to complete the zoom-in data query. Decisive factors include identifying if a subject vehicle is being asked to perform multiple tasks related to other queries, a profile of data traffic within a geographic range, quantity of vehicles within range, etc., and an evaluation of a likelihood or probability of data loss. Zoom-in data queries that are requested from multiple proximal vehicles can result in exponential growth in communications, resulting in saturation and overloading of the available communication bandwidth and a loss of relevant data.

The adaptive 2-dimensional zoom-in search algorithm 600 can execute an evaluation of the available communication bandwidth for a data query to determine an overload factor for the data query, taking into account the quantity of proximal, available vehicles and the potential for the zoom-in query to include system data, subsystem data, and/or sensor data. The evaluation of the available communication bandwidth includes a determination that a zoom-in query will success when the data transfer from the proximal, available vehicles and the system data, subsystem data, and/or sensor data responsive to the data query is less than the bandwidth.

The concepts described herein provide an architecture having an in-vehicle data watcher capability with a well-defined, multi-level vehicle data pyramid framework. The cloud applications guide the collection process and ask for relevant information, which could be ranging from high-level system level information to very detailed sensor outputs to achieve root cause analysis of an issue, which may be difficult to predict or simply unknown initially, while managing communication burdens, i.e., avoiding unnecessarily large data transfers. The iterative two-dimensional zoom-in capability enables real-time task inquiries from the cloud to the subject vehicle 10, ensuring fast vehicle-cloud interactions for latency-sensitive use cases. This includes a close collaborative exchange between vehicle data watcher and cloud-based zoom-in capability using a structured vehicle data hierarchy, to bring iterative real-time task control and structured vehicle data collection together.

The teachings may be described herein in terms of functional and/or logical block components and/or various processing steps. It should be realized that such block components may be composed of hardware, software, and/or firmware components that have been configured to perform the specified functions. Embodiments may also be implemented in cloud computing environments. The flowchart and block diagrams in the flow diagrams illustrate the architecture, functionality, and operation of possible implementations of systems, methods, and computer program products according to various embodiments of the present disclosure. In this regard, each block in the flowchart or block diagrams may represent a module, segment, or portion of code, which includes one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a controller or other programmable data processing apparatus to function in a particular manner, such that the instructions stored in the computer-readable medium produce an article of manufacture including instructions to implement the function/act specified in the flowchart and/or block diagram block or blocks.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

What is claimed is:

1. A system for dynamically configurable remote data collection from a subject vehicle, the system comprising:
a plurality of vehicle sensors, a plurality of first-level controllers, a plurality of second-level controllers, a data watcher routine, a data compiler, a configuration manager, and a telematics system arranged on the subject vehicle;
a second controller; and
wherein the telematics system effects wireless communication between the subject vehicle and the second controller;
wherein the second controller is an off-board controller that is located remotely from the subject vehicle;
wherein the plurality of vehicle sensors, the plurality of first-level controllers, and the plurality of second-level controllers generate a plurality of parameters;
wherein the second controller generates a task-specific data query to obtain a subset of the plurality of parameters in response to a request from an external application;
wherein the second controller communicates, via the telematics system, the task-specific data query to the configuration manager to request the subset of the plurality of parameters;
wherein the data watcher routine captures and communicates the subset of the plurality of parameters to the data compiler; and
wherein the data compiler communicates the subset of the plurality of parameters to the second controller.

2. The system of claim 1, wherein the second controller arranges the plurality of parameters into a data hierarchy, and wherein the second controller generates the task-specific data query to obtain the subset of the plurality of parameters that is consistent with the data hierarchy.

3. The system of claim 2, wherein the data hierarchy is arranged as sensor data, subsystem data, system data, and vehicle data.

4. The system of claim 2, wherein the configuration manager arranges the data hierarchy to include sensor data, subsystem data, system data, and vehicle data.

5. The system of claim 2, wherein the task-specific data query is iterative, including the configuration manager being arranged to initially request vehicle data, followed by a request for at least one of system data, subsystem data, and sensor data in response to the task-specific data query to form the subset of the plurality of parameters; and
wherein the data watcher routine captures and communicates the subset of the plurality of parameters to the data compiler.

6. The system of claim 2, wherein the configuration manager is arranged to initially request vehicle data, followed by a request for at least one of system data, subsystem data, and sensor data in response to the task-specific data query to form the subset of the plurality of parameters; and
wherein the data watcher routine captures and communicates the subset of the plurality of parameters to the data compiler.

7. The system of claim 1, wherein the second controller is configured to arrange the task-specific data query to obtain the subset of the plurality of parameters such that the task-specific data query requests data that is consistent with a data hierarchy of the configuration manager, including sensor data, subsystem data, system data, and vehicle data.

8. The system of claim 1, wherein the configuration manager is arranged to request the subset of the plurality of parameters, including one of vehicle data, system data, subsystem data, or sensor data, in response to the task-specific data query;
wherein the subset of the plurality of parameters includes one of vehicle data, system data, subsystem data, or sensor data; and
wherein the data watcher routine captures and communicates the subset of the plurality of parameters to the data compiler.

9. The system of claim 1, wherein the second controller comprises a cloud-based controller.

10. The system of claim 1, wherein the task-specific data query is iterative, including the second controller being arranged to request data from proximal, similarly situated vehicles in response to the task-specific data query.

11. The system of claim 10, wherein the second controller being arranged to request data from proximal, similarly situated vehicles in response to the task-specific data query comprises the second controller being arranged to request data from the proximal, similarly situated vehicles at a same hierarchical data level as the subject vehicle in response to the task-specific data query.

12. The system of claim 1, wherein the task-specific data query is iterative, and wherein the second controller is arranged to request data from a proximal, similarly situated vehicle at a same hierarchical data level as the subject vehicle in response to the task-specific data query.

13. The system of claim 1, wherein the plurality of vehicle sensors are arranged to monitor operation of the subject vehicle.

14. The system of claim 1, wherein the plurality of first-level controllers comprise dedicated controllers that execute task-specific operations.

15. The system of claim 1, wherein the plurality of second-level controllers comprise system-level controllers that monitor and control the plurality of first-level controllers.

16. A method for collecting data from a subject vehicle, the method comprising:
generating, via a second controller, a task-specific data query to obtain a plurality of parameters in response to a request from an external application;
communicating, via a telematics system, the task-specific data query to an on-vehicle configuration manager to request the plurality of parameters;
capturing, via an on-vehicle data compiler, the plurality of parameters; and
communicating the plurality of parameters to the second controller;
wherein the plurality of parameters are arranged in a data hierarchy; and
wherein the second controller generates the task-specific data query to obtain the plurality of parameters that is consistent with the data hierarchy.

17. The method of claim 16, wherein the data hierarchy is arranged as sensor data, subsystem data, system data, and vehicle data.

18. The method of claim 16, wherein the task-specific data query is iterative, including the configuration manager being arranged to request vehicle data, and at least one of a request for system data, a request for subsystem data, and a request for sensor data in response to the task-specific data query.

19. The method of claim 18, further comprising requesting, via the second controller, data from proximal, similarly situated vehicles in response to the task-specific data query.

20. The method of claim 19, wherein requesting, via the second controller, data from proximal, similarly situated vehicles in response to the task-specific data query comprises request data from the proximal, similarly situated vehicles at a same hierarchical data level as the subject vehicle in response to the task-specific data query.
